(19) United States
(12) Patent Application Publication
(10) Pub. No.: US 2012/0193994 A1
(43) Pub. Date: Aug. 2, 2012

(54) POWER RECEIVING DEVICE, POWER SUPPLY SYSTEM, AND METHOD FOR SUPPLYING POWER

(75) Inventor: Koichiro KAMATA, Isehara (JP)

(73) Assignee: SEMICONDUCTOR ENERGY LABORATORY CO., LTD., Atsugi-shi (JP)

(21) Appl. No.: 13/330,742

(22) Filed: Dec. 20, 2011

(30) Foreign Application Priority Data
Jan. 28, 2011 (JP) 2011-016645

(51) Int. Cl. H01F 38/14

(52) U.S. Cl. 307/104

(57) ABSTRACT

A power transmitting system in which power can be successfully supplied by magnetic resonance from a power transmitting device to a selected power receiving device among a plurality of power receiving devices. The power receiving device includes a variable unit which can change the self resonant frequency of a resonance coil in accordance with an invalidation signal transmitted from the power transmitting device. Thus, even in the case where the plurality of power receiving devices are provided for one power transmitting device, the self resonant frequencies of the resonance coils included in the power receiving devices which are not to be supplied with power are changed to avoid resonance with the power transmitting device. Consequently, power can be successfully and selectively supplied to the power receiving devices to be supplied with power.

### BACKGROUND OF THE INVENTION

1. Field of the Invention

The present invention relates to power receiving devices. In particular, the present invention relates to power receiving devices to which power is supplied by magnetic resonance. Further, the present invention relates to power supply systems including the power receiving devices and methods for, supplying power in the power supply systems.

2. Description of the Related Art

A method called a magnetic resonance method attracts attention as a Method for supplying power to an object (hereinafter also referred to as a power receiving device) in a state where contact with a power supply source (hereinafter also referred to as a power transmitting device) is not made (such a method is also referred to as contactless power supply, wireless power supply, or the like). The magnetic resonance method is a method for forming an energy propagation path by making resonance coils provided in a power transmitting device and a power receiving device magnetically resonate with each other. The magnetic resonance method has a longer power transmittable distance than other methods (e.g., an electromagnetic induction method and a field induction method). For example, Reference 1 discloses that in the magnetic resonance method, transmission efficiency is approximately 90% when the distance between resonance coils is 1 m and that the transmission efficiency is approximately 45% when the distance between the resonance coils is 2 m.

### REFERENCE

Reference 1: Andre Kurs et al., “Wireless Power Transfer via Strongly Coupled Magnetic Resonances”, Science, 2007, Vol. 317, pp. 83-86.

### SUMMARY OF THE INVENTION

In the magnetic resonance method, power is supplied by magnetic coupling in a state where a pair of resonance coils resonate with each other. Thus, in the case where a plurality of power receiving devices are provided for one power transmitting device, the magnetic fields of resonance coils included in the plurality of power receiving devices interfere with each other, so that it is difficult to supply power to the power receiving devices by magnetic resonance. Consequently, it is an object of one embodiment of the present invention to provide a power receiving device to which power can be successfully supplied by magnetic resonance even in the case where a plurality of power receiving devices are provided for one power transmitting device.

The object can be achieved by provision of a variable unit for changing the self resonance characteristics of a resonance coil included in a power receiving device.

Specifically, one embodiment of the present invention is a power receiving device that includes a power receiving resonance coil in which high-frequency voltage is induced by magnetic resonance, a variable unit for changing the self resonant frequency of the power receiving resonance coil, a load coil in which high-frequency voltage is induced by electromagnetic induction with the power receiving resonance coil, a load whose one end is connected to one end of the load coil and whose other end is connected to the other end of the load coil, a power receiving demodulation circuit for demodulating a signal from the high-frequency voltage induced in the load coil, a response unit for responding to the signal demodulated in the power receiving demodulation circuit, and a power receiving controller for controlling the operation of the variable unit and the response unit in accordance with the signal demodulated in the power receiving demodulation circuit.

A power supply system that includes the power receiving device and a power transmitting device including a power transmitting controller, a high-frequency power source for generating high-frequency voltage, a modulation circuit for modulating the high-frequency voltage in accordance with a signal generated in the power transmitting controller, a drive coil to which the high-frequency voltage modulated in the modulation circuit is applied, a power transmitting resonance coil in which high-frequency voltage is induced by electromagnetic induction with the drive coil and which induces high-frequency voltage by magnetic resonance in resonance coils whose self resonant frequencies are the same or substantially the same, and a power transmitting demodulation circuit for demodulating the high-frequency voltage applied to the drive coil is also one embodiment of the present invention. In the power receiving resonance coil, high-frequency voltage is induced by magnetic resonance with the power transmitting resonance coil.

A method for supplying power from a power transmitting device to any one of a plurality of power receiving devices by magnetic resonance is also one embodiment of the present invention. The method includes a first step of transmitting an inventory signal that requests a response whether power supply is necessary from the power transmitting device, a second step of responding to the inventory signal in each of the plurality of power receiving devices, a third step of transmitting an invalidation signal that requests a change in self resonant frequency of the power receiving resonance coil to the power receiving device to which power is not supplied from the power transmitting device, and a fourth step of supplying power to the power receiving device to which power is supplied from the power transmitting device.

The power receiving device in one embodiment of the present invention includes a variable unit for changing the self resonant frequency of a resonance coil. Thus, even in the case where a plurality of power receiving devices are provided for one power transmitting device, it is possible to change the self resonant frequencies of the resonance coils included in the power receiving devices other than the power receiving device to which power is supplied. Consequently, power can be successfully supplied to the power receiving devices by magnetic resonance.

The power supply system in one embodiment of the present invention also includes a power transmitting device that includes a power transmitting resonance coil which induces high-frequency voltage by magnetic resonance in resonance coils whose self resonant frequencies are the same or substantially the same, and a power receiving device that includes a power receiving resonance coil in which high-frequency voltage is induced by magnetic resonance with the power transmitting resonance coil. Thus; the power transmitting resonance coil and the power receiving resonance coil can be easily made to resonate with each other magnetically. Further, in the power supply system in one embodiment of the present invention, whether to change the self resonant frequency of the power receiving resonance coil can be selected by the power transmitting device. Consequently, even in the case where a plurality of power receiving devices are provided for one power transmitting device, the power transmitting device can select any one of the plurality of power receiving devices to which power is supplied. In other words, power can be successfully supplied to any one of the plurality of power receiving devices. Furthermore, in the power supply system in one embodiment of the present invention, power can be supplied with a simple structure.

In the method for supplying power in one embodiment of the present invention, invalidation signals that request changes in self resonant frequencies of the power receiving resonance coils are transmitted to the power receiving devices other than the power receiving device to which power is supplied. Then, power is supplied to the power receiving device to which power is supplied: Consequently, even in the case where a plurality of power receiving devices are provided for one power transmitting device, power can be successfully supplied to the power receiving device to which power is supplied by magnetic resonance.

### BRIEF DESCRIPTION OF THE DRAWINGS

In the accompanying drawings:

FIG. 1 illustrates a structure example of a power receiving device;

FIG. 2 illustrates a structure example of a power supply system;

FIG. 3 is a flow chart illustrating an operation example of a power supply system; and

FIGS. 4A and 4B illustrate applications of a power supply system.

### DETAILED DESCRIPTION OF THE INVENTION

Embodiments and an example of the present invention will be described in detail below with reference to the drawings. Note that the present invention is not limited to the following description. It will be readily appreciated by those skilled in the art that modes and details of the present invention can be modified in various ways without departing from the spirit and scope of the present invention. The present invention therefore should not be construed as being limited to the following description of the embodiments and the example.

### Embodiment 1

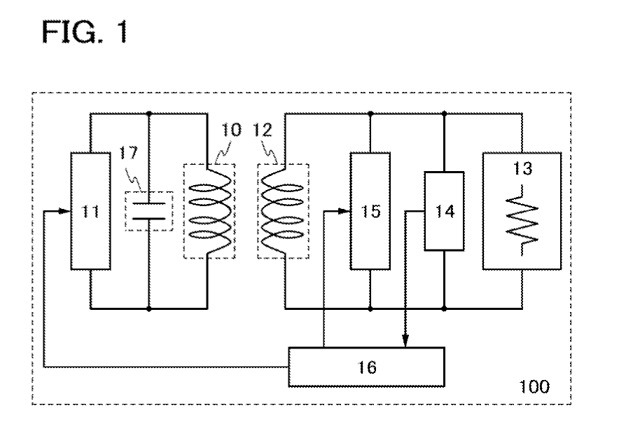

In this embodiment, an example of a power receiving device according to one embodiment of the present invention is described with reference to FIG. 1. Note that the power receiving device is a power receiving device to which power is supplied by magnetic resonance.

### <Structure Example of Power Receiving Device>

FIG. 1 illustrates a power receiving device in this embodiment. The power receiving device illustrated in FIG. 1 includes a resonance coil 10 in which high-frequency voltage is induced by magnetic resonance; a variable unit 11 for changing the self resonant frequency of the resonance coil 10, a coil 12 in which high-frequency voltage is induced by electromagnetic induction with the resonance coil 10, a load 13 whose one end is connected to one end of the coil 12 and whose other end is connected to the other end of the coil 12, a demodulation circuit 14 for demodulating a signal from the high-frequency voltage excited in the coil 12, a response unit 15 for responding to the signal demodulated in the demodulation circuit 14, and a controller 16 for controlling the operation of the variable unit 11 and the response unit 15 in accordance with the signal demodulated in the demodulation circuit 14. Further, in the resonance coil 10, stray capacitance 17 exists between wirings.

Note that in FIG. 1, the resonance coil 10 and the coil 12 are separately provided; however, these coils can be merged into a single coil. In that case, the series resistance and capacitance of the coil are increased. This indicates that a Q factor is decreased. Thus, as illustrated in FIG. 1, it is preferable to provide the resonance coil 10 and the coil 12 separately.

The structure of the variable unit 11 may be any structure as long as the self resonant frequency of the resonance coil 10 can be changed reversibly. For example, a switch which is provided between one end and the other end of the resonance coil 10 and whose switching is controlled by the controller 16 can be used as the variable unit 11. Note that in the case where a switch is used as the variable unit 11, it is preferable to use a mechanical switch (e.g., a mechanical relay or a MEMS switch) for controlling whether a contact exists. This is because high frequency voltage might be applied to the variable unit 11.

The internal structure of the load 13 is not limited to a certain structure. For example, the load 13 can include an AC-DC converter, a DC-DC converter, a battery, or the like. In particular, the load 13 preferably includes a battery on which charging is performed on the basis of high-frequency voltage induced in the coil 12. This is because in the case where magnetic resonance is utilized, power can be supplied with high efficiency even in a middle and long distance. The load 13 can include a matching circuit whose impedance is controlled by the controller 16. When the impedance of the load 13 is controlled by the controller 16, power transmission efficiency at the time when the distance between an external power transmitting device and the power receiving device is shorter than an optimal distance can be improved, for example.

The demodulation circuit 14 may be any circuit as lone as it can determine a signal superposed on high-frequency voltage (e.g., a signal superposed on high-frequency voltage by amplitude modulation) and can output the signal as a digital signal.

The structure of the response unit 15 may be any structure as long as it can respond to the external power transmitting device. For example, a resistor and a switch which are provided between the one end and the other end of the coil 12 and are connected in series can be used as the response unit 15. In that case, the resistor and the switch can respond to the external power transmitting device by control of switching of the switch with the controller 16. Further, a mechanical switch is preferably used as the switch.

Further, in the power receiving device illustrated in FIG. 1, only the stray capacitance 17 between the wirings exists in the resonance coil 10; however, a capacitor can be provided between the one end and the other end of the resonance coil 10.

### <Operation Example of Power Receiving Device 5>

The operation of the power receiving device illustrated in FIG. 1 is described below.

First, high-frequency voltage is induced in the resonance coil 10 by magnetic resonance with a resonance coil included in the external power transmitting device. Then, the high-frequency voltage which is induced in the resonance coil 10 is transmitted to the coil 12 by electromagnetic induction. In other words, high-frequency voltage based on the high-frequency voltage which is induced in the resonance coil 10 is induced in the coil 12. A signal superposed on the high-frequency voltage which is induced in the coil 12 is demodulated in the demodulation circuit 14. The signal which is demodulated in the demodulation circuit 14 is input to the controller 16. The controller 16 controls the operation of the variable unit 11 and the response unit 15 with the signal.

Note that there are at least two kinds of signals (an inventory signal and an invalidation signal) that are demodulated in the demodulation circuit 14. The inventory signal requests a response whether the external power transmitting device needs to supply power to the power receiving device. The invalidation signal makes the external power transmitting device request a change in self resonant frequency of the resonance coil 10 in the power receiving device. Thus, the controller 16 responds to the external power transmitting device by controlling the operation of the response unit 15 in the case where the inventory signal is input. Further, the controller 16 changes the self resonant frequency of the resonance coil 10 by controlling the operation of the variable unit 11 in the case where the invalidation signal is input.

Then, in the case where the inventory signal is input and the power receiving device responds to the inventory signal that power supply is needed (excluding the case where the power receiving device receives the invalidation signal after that), power is supplied from the external power transmitting device to the load 13. Note that power is supplied from the external power transmitting device to the load 13 through the resonance coil 10 and the coil 12. In the case where the power receiving device receives the invalidation signal, the self resonant frequency of the resonance coil 10 is changed over a certain period. Note that after the certain period, the self resonant frequency of the resonance coil 10 is restored.

In this manner, in the power receiving device in this embodiment, the self resonant frequency of the resonance coil 10 can be changed in accordance with an invalidation signal transmitted from the external power transmitting device. Thus, it is possible to prevent the resonance coil included in the external power transmitting device and the resonance coil 10 included in the power receiving device from magnetically resonating with each other. Consequently, even in the case where a plurality of power receiving devices are provided for one external power transmitting device, one of the power receiving devices is selected so that power can be successfully supplied to the power receiving device by magnetic resonance.

Further, in the power receiving device in this embodiment, a mechanism for supplying and receiving signals and a mechanism for supplying power are not separately provided, but signal transmission and reception and power supply are performed through the resonance coil 10 and the coil 12. Thus, the power receiving device can be made small.

Note that this embodiment or part of this embodiment can be combined with the other embodiment, part of the other embodiment, the example, or part of the example as appropriate.

### Embodiment 2

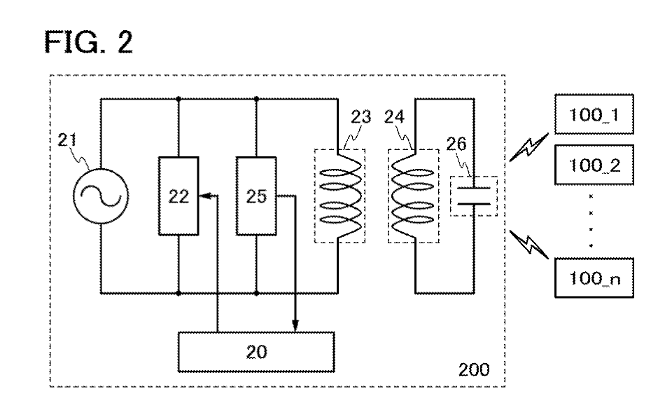

In this embodiment, an example of a power supply system according to one embodiment of the present invention is described with reference to FIG. 2. Note that the power supply system is a power supply system for supplying power by magnetic resonance.

### <Structure Example of Power Supply System>

FIG. 2 illustrates a power supply system in this embodiment. The power supply system illustrated in FIG. 2 includes a plurality of power receiving devices 100_1 to 100_{—}n is a natural number of 2 or more) and a power transmitting device 200. Here, the plurality of power receiving devices 100_1 to 100_{—}n each include at least a resonance coil whose self resonant frequency is the same as or substantially the same as the self resonant frequency of a resonance coil 24 included in the power transmitting device 200. In this embodiment, the power receiving device in Embodiment 1 is used as each of the plurality of power receiving devices 100_1 to 100_{—}n. Thus, in this embodiment, the description in Embodiment 1 is referred to for those of the power receiving devices 100_1 to 100_{—}n. Note that in the power supply system in this embodiment, the plurality of power receiving devices 100_1 to 100_{—}n do not necessarily have the same structures. In other words, there is no need for the plurality of power receiving devices 100_1 to 100_{—}n to have the same structures or functions.

The power transmitting device 200 includes a controller 20, a high-frequency power source 21 for generating high-frequency voltage, a modulation circuit 22 for modulating the high-frequency voltage in accordance with a signal generated in the controller 20, a coil 23 to which the high-frequency voltage modulated in the modulation circuit 22 is applied, the resonance coil 24 in which high-frequency voltage is induced by electromagnetic induction with the coil 23, and a demodulation circuit 25 for demodulating the high-frequency voltage applied to the coil 23. Further, in the resonance coil 24, stray capacitance 26 exists between wirings.

Note that the structure of the high-frequency power source 21 may be any structure as long as high-frequency voltage whose frequency is equal to the self resonant frequency of the resonance coil 24 can be generated.

The structure of the modulation circuit 22 may be any structure as long as a signal can be superposed (e.g., amplitude modulation can be performed) with the use of high-frequency voltage as a carrier wave.

In FIG. 2, the coil 23 and the resonance coil 24 are separately provided; however, these coils can be merged into a single coil. In that case, the series resistance and capacitance of the coil are increased. This indicates that a Q factor is decreased. Thus, as illustrated in FIG. 2, it is preferable to provide the coil 23 and the resonance coil 24 separately.

The demodulation circuit 25 may be any circuit as long as it can determine a signal superposed on high-frequency voltage (e.g., a signal superposed on high-frequency voltage by amplitude modulation) and can output the signal as a digital signal.

### <Method for Supplying Power Using Power Supply System>

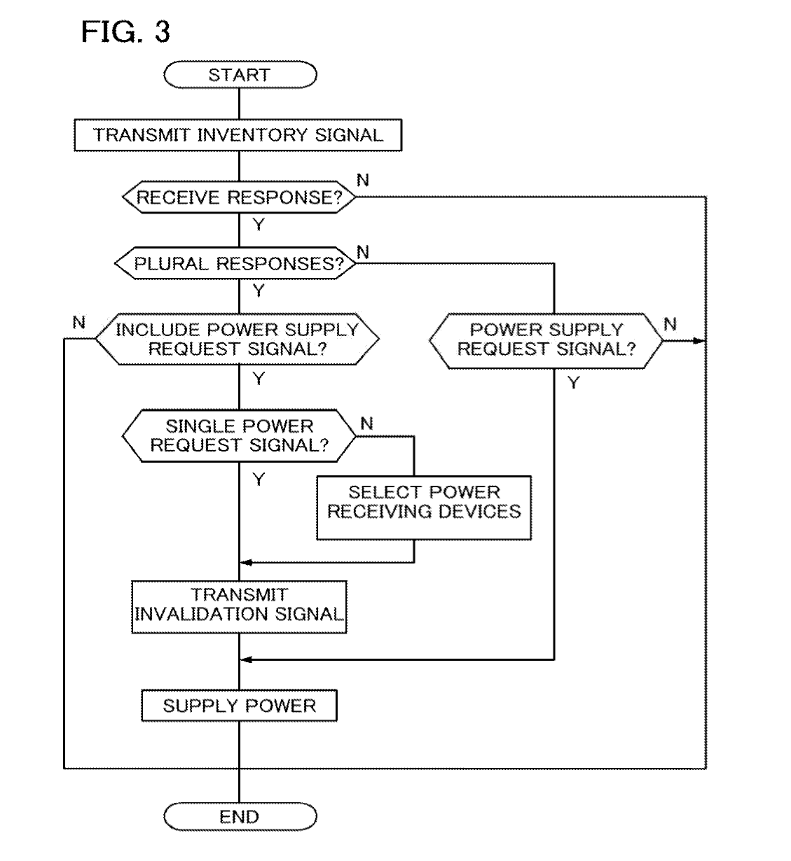

An example of a method for supplying power using the power supply system in this embodiment is described below with reference to FIG. 3. Note that FIG. 3 is a flow chart illustrating an operation example of a power transmitting device in the power supply system.

The power transmitting device transmits an inventory signal that requests a response whether the power transmitting device needs to supply power to the power receiving device. Note that the inventory signal can be transmitted constantly, regularly, or irregularly from the power transmitting device (e.g., the inventory signal is supplied according to user's operation) until a response signal from the power receiving device is received. Further; in order to avoid interference in responses transmitted from the plurality of power receiving devices, the power supply system preferably has a collision avoidance function (an anti-collision function).

In the case where the power transmitting device receives a response (in the case where there is a power receiving device that responds to the inventory signal), the operation of the power transmitting device varies depending on whether the number of responses is plural (whether the number of power receiving devices that respond to the inventory signal is plural). In contrast, in the case where the power transmitting device receives no response (in the case where there is no power receiving device that responds to the inventory signal), power supply operation is terminated.

In the case where the number of responses is single, the power transmitting device determines whether the response is a signal that requests power supply (a power supply request signal). When the response is a power supply request signal, the power transmitting device supplies power to the power receiving device from which the power supply request signal is transmitted. In contrast, when the response is not a power supply request signal, power supply operation is terminated.

In the case where the number of responses is plural, the power transmitting device determines whether the plurality of responses include a power supply request. When the plurality of responses include a power supply request, the power transmitting device determines whether the number of power supply requests is single. In contrast, when the plurality of responses do not include a power supply request, power supply operation is terminated.

In the case where the number of power supply requests included in the plurality of responses is single, the power transmitting device transmits invalidation signals that request changes in self resonant frequencies of resonance coils in the power receiving devices other than the power receiving device that transmits a power supply request response (the power receiving device to which power is supplied). In contrast, in the case where the number of power supply requests included in the plurality of responses is plural, the power transmitting device selects any one of the plurality of power receiving devices that transmit power supply request responses (the power receiving device to which power is supplied). Then, invalidation signals are transmitted to the power receiving devices other than the power receiving device to which power is supplied.

Through such operation, power can be successfully supplied to the single power receiving device from the power transmitting device.

In this embodiment, the power supply is terminated after a certain period. Then, the power transmitting device transmits an inventory signal again and the above operations are repeated. Through these operations, even if a plurality of power receiving devices transmit power supply request signals, supply of power to the plurality of power receiving devices can be performed one by one. Additionally, appropriate control of the power supply period allows the supply of power to the plurality of power receiving device in quasi-parallel.

Note that in the above operations, the plurality of power receiving devices transmit responses whether the power receiving devices request power supply; however, the operation example of this embodiment is not limited to this structure. For example, the plurality of power receiving devices can transmit signals indicating their conditions (e.g., charging conditions) to the power transmitting device, and the power transmitting device can select the power receiving device to which power is supplied on the basis of the signals.

In this manner, in the power supply system in this embodiment, the self resonant frequency of the resonance coil included in the power receiving device can be changed in accordance with an invalidation signal transmitted from the power transmitting device. Consequently, even in the case where a plurality of power receiving devices are provided for one power transmitting device, power can be successfully supplied by magnetic resonance.

Further, in the power supply system in this embodiment, the self resonant frequencies of the power transmitting resonance coil included in the power transmitting device and the power receiving resonance coil included in the power receiving device are the same or substantially the same. Thus, these resonance coils can be easily made to magnetically resonate with each other. In other words, in the power supply system in this embodiment, power supply utilizing magnetic resonance can be performed with a simple structure.

Note that this embodiment or part of this embodiment can be combined with the other embodiment, part of the other embodiment, the example, or part of the example as appropriate.

### EXAMPLE 1

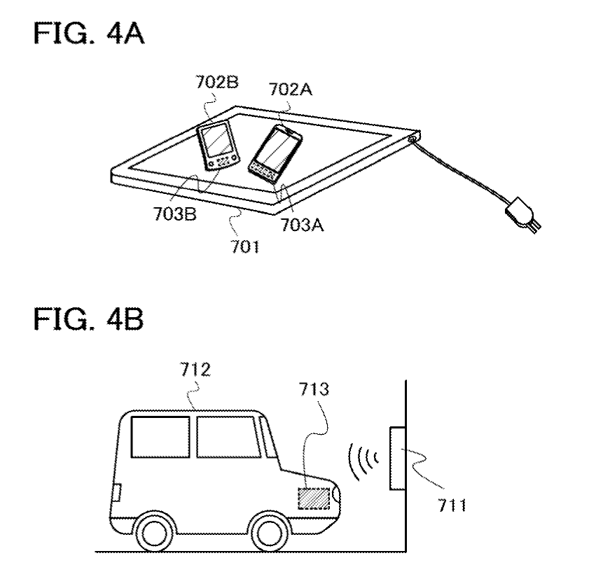

In this example, applications of the power supply system in Embodiment 2 are described. Note that as applications of a power supply system according to one embodiment of the present invention, portable electronic devices such as a digital video camera, a portable information terminal (e.g., a mobile computer, a cellular phone, a portable game machine, or an e-book reader), and an image reproducing device including a recording medium (specifically a digital versatile disc (DVD) reproducing device) can be given. In addition, an electric propulsion moving vehicle that is powered by electric power, such as an electric car, can be given. Examples of such electronic devices are described below with reference to FIGS. 4A and 4B.

FIG. 4A illustrates an application of a power supply system to a cellular phone and a portable information terminal in which a power transmitting device 701, a cellular phone 702A including a power receiving device 703A, and a cellular phone 702B including a power receiving device 703B are included. The power supply system in Embodiment 2 can be provided for the power transmitting device 701 and the power receiving devices 703A and 703B.

For example, the power transmitting device in Embodiment 2 can be applied to the power transmitting device 701, and the power receiving device in Embodiment 1 can be applied to the power receiving device 703A and the power receiving device 703B.

By application of the power supply system according to one embodiment of the present invention, power can be efficiently supplied from the power transmitting device 701 to the power receiving device 703A and the power receiving device 703B.

FIG. 4B illustrates an application of a power supply system to an electric car that is an electric propulsion moving vehicle in which a power transmitting device 711 and an electric car 712 including a power receiving device 713 are included. The power supply system in Embodiment 2 can be provided for the power transmitting device 711 and the power receiving device 713.

For example, the power transmitting device in Embodiment 2 can be applied to the power transmitting device 711, and the power receiving device in Embodiment 1 can be applied to the power receiving device 713.

By application of the power supply system according to one embodiment of the present invention, power can be efficiently supplied from the power transmitting device 711 to the power receiving device 713.

As described above, the power supply system in Embodiment 2 can be used in any object that is driven with power.

Note that this example or part of this example can be combined with any of the embodiments or part of any of the embodiments as appropriate.

This application is based on Japanese Patent Application serial No. 2011-016645 tiled with Japan Patent Office on Jan. 28, 2011, the entire contents of which are hereby incorporated by reference.

What is claimed is:

1. A power supply system comprising:
a power transmitting device comprising a power transmitting resonance coil; and
a power receiving device comprising a power receiving resonance coil,
wherein the power transmitting device comprises means for transmitting an invalidation signal to the power receiving device, and
wherein the power receiving device comprises means for changing a self resonant frequency of the power receiving resonance coil so as to prevent the power receiving resonance coil from resonating with the power transmitting resonance coil upon receiving the invalidation signal.

2. The power supply system according to claim 1, wherein the power transmitting device comprises:
means for transmitting an inventory signal to the power receiving device; and
means for receiving a response to the inventory signal from the power receiving device.

3. The power supply system according to claim 2, wherein the power transmitting device comprises means for determining whether the response is a power supply request signal which requests the power transmitting device to supply power to the power receiving device.

4. The power supply system according to claim 2, wherein the power receiving device comprises:
means for receiving the inventory signal; and
means for transmitting the response to the power transmitting device.

5. A power supply system comprising:
a power transmitting device comprising a power transmitting resonance coil; and
a plurality of power receiving devices each comprising a power receiving resonance coil,
wherein the power transmitting device comprises means for transmitting an invalidation signal to the plurality of power receiving devices, and
wherein each of the plurality of power receiving devices comprises means for changing a self resonant frequency of the power receiving resonance coil so as to prevent the power receiving resonance coil from resonating with the power transmitting resonance coil upon receiving the invalidation signal.

6. The power supply system according to claim 5,
wherein the power transmitting device comprises means for transmitting an inventory signal to the plurality of power receiving devices, and
wherein the plurality of power receiving devices each comprise means for receiving the inventory signal and means for transmitting a response to the inventory signal to the power transmitting device.

7. The power supply system according to claim 6, wherein the power transmitting device comprises means for receiving the responses from the plurality of power receiving devices.

8. The power supply system according to claim 7, wherein the power transmitting device comprises means for determining whether the responses include a power supply request signal which requests the power transmitting device to supply power to the plurality of power receiving devices.

9. The power supply system according to claim 8, wherein the power transmitting device comprises means for selecting one of the plurality of power receiving devices, which transmits the power supply request signal as the response.

10. A power supply system comprising:
a power transmitting device comprising a power transmitting resonance coil; and
a power receiving device comprising a power receiving resonance coil,
wherein the power transmitting device is capable of transmitting an invalidation signal to the power receiving device, and
wherein the power receiving device is capable of changing a self resonant frequency of the power receiving resonance coil so as to prevent the power receiving resonance coil from resonating with the power transmitting resonance coil upon receiving the invalidation signal.

11. The power supply system according to claim 10, wherein the power transmitting device is capable of transmitting an inventory signal to the power receiving device and receiving a response to the inventory signal from the power receiving device.

12. The power supply system according to claim 11, wherein the power transmitting device is capable of determining whether the response is a power supply request signal which requests the power transmitting device to supply power to the power receiving device.

13. The power supply system according to claim 11, wherein the power receiving device is capable of receiving the inventory signal and the invalidation signal from the power transmitting device and transmitting the response to the power transmitting device.

14. A power supply system comprising:
a power transmitting device comprising a power transmitting resonance coil; and
a plurality of power receiving devices each comprising a power receiving resonance coil,
wherein the power transmitting device is capable of transmitting an invalidation signal to the plurality of power receiving devices, and
wherein each of the plurality of power receiving devices is capable of changing a self resonant frequency of the power receiving resonance coil so as to prevent the power receiving resonance coil from resonating with the power transmitting resonance coil upon receiving the invalidation signal.

15. The power supply system according to claim 14,
wherein the power transmitting device is capable of transmitting an inventory signal to the plurality of power receiving devices, and
wherein the plurality of power receiving devices are each capable of receiving the inventory signal and transmitting a response to the inventory signal.

16. The power supply system according to claim 15, wherein the power transmitting device is capable of receiving the responses from the plurality of power receiving devices.

17. The power supply system according to claim 16, wherein the power transmitting device is capable of determining whether the responses include a power supply request signal which requests the power transmitting device to supply power to the plurality of power receiving devices.

18. The power supply system according to claim 17, wherein the power transmitting device is capable of selecting one of the plurality of power receiving devices, which transmits the power supply request signal as the response.

19. A method for supplying power from a power transmitting device to a power receiving device, the method comprising the steps of:
transmitting an invalidation signal from the power transmitting device to the power receiving device; and
changing a self resonant frequency of a power receiving resonance coil of the Power receiving device so as to prevent the power receiving resonance coil from resonating with a power transmitting resonance coil of the power transmitting device when the power receiving device receives the invalidation signal.

20. The method according to claim 19, further comprising the steps of:
transmitting an inventory signal from the power transmitting device to the power receiving device; and
transmitting a response to the inventory signal from the power receiving device to the power transmitting device.

21. The method according to claim 20, further comprising the step of determining whether the response is a power supply request signal which requests the power transmitting device to supply power to the power receiving device.

22. A method for supplying power from a power transmitting device to a plurality of power receiving devices, the method comprising the steps of:
transmitting an invalidation signal from the power transmitting device to at least one of the plurality of power receiving devices; and
changing a self resonant frequency of a power receiving resonance coil of the one of the plurality of power receiving devices so as to prevent the power receiving resonance coil from resonating with a power transmitting resonance coil of the power transmitting device when the one of the plurality of power receiving devices receives the invalidation signal.

23. The method according to claim 22, further comprising the steps of:
transmitting an inventory signal from the power transmitting device to the plurality of power receiving devices, and
transmitting a response to the inventory signal from the: one of the Plurality of power receiving devices to the power transmitting device.

24. The method according to claim 23, further comprising the steps of:
receiving the responses from the plurality of power receiving devices by the power transmitting device, and
determining whether the responses include a power supply request signal which requests the power transmitting device to supply power to the plurality of power receiving devices

25. The method according to claim 24, further comprising the step of:
selecting one of the plurality of power receiving devices, which transmits the power supply request signal.
